(19) United States
(12) Patent Application Publication
(10) Pub. No.: US 2006/0150947 A1
(43) Pub. Date: Jul. 13, 2006

(54) Revolving piston internal combustion engine

(76) Inventor: Vishvas Ambardekar, Pune (IN)

Correspondence Address: Vishvas Ambardekar;V.S Ambardekar "Snehal", Plot No B 82 Flat No 2, Tulshibagwale Colony, Pune, 411009, IN

(21) Appl. No.: 10/545,251

(22) PCT Filed: Feb. 13, 2003
(86) PCT No.: PCT/IN03/00025

§ 371 Date: Aug. 10, 2005

(51) Int. Cl. F02B 53/00

(52) U.S. Cl. 123/241; 123/245

(57) ABSTRACT

To reduce the losses of a conventional reciprocating piston engine and to facilitate easy cooling, a new type of engine is conceptualized here. This invention deals with a new concept to make an engine to utilize easy sealing, easy cooling properties of the reciprocating piston engine and low vibration, low losses properties of rotary piston engine. In this engine, pairs of revolving pistons, consisting of one piston and one cylinder head, revolve within a ring cylinder, around an axis in same direction but with different velocities. It is more appropriate to call the present concept engine as a “revolving piston engine”. These types of engines can be used in automobiles, aero industries, battlefield tanks, power-generation and in many other applications. The same concept can be used to develop a revolving piston compressor with appropriately designing and relocating the ports or valves for the intake and outlet.

### BACKGROUND

Conventional internal combustion engines, consisting of a cylinder, a crank, a connecting rod and a piston, are used very widely, in day-to-day life. These reciprocating piston engines are designed with different capacities for various applications using different types of fuels. To reduce the work loss due to the reciprocating piston in engines, different engines were made without a reciprocating piston. In such efforts, a Wenkel engine was designed with a rotary piston, that rotates continuously in one direction, thus reducing the losses which otherwise would have caused by the reciprocating motion of the piston in a conventional reciprocating piston internal combustion engine. In these Wenkel engines, appropriate cooling and sealing have become very difficult and probably for these reasons the engine could not become very popular in industries. Gas turbines are another type of non-reciprocating piston engines and are widely used, these turbines have very high values of power to weight ratio and work most efficiently at very high speeds and thus generally not used for automobiles. A need for an engine without a reciprocating piston, to have easy cooling and should be efficient to operate at lower speeds, is always felt. Present work is related to a new concept engine that has a pair of revolving pistons instead of a reciprocating or rotary piston.

### INTRODUCTION

To reduce the losses of a conventional reciprocating piston engine and to facilitate easy cooling, a new type of engine is conceptualized here. A new approach is used to make the present concept engine to utilize, easy sealing and easy cooling properties of a reciprocating piston engine, and low vibration and low losses properties of a rotary piston engine. It is more appropriate to call the present concept engine as a “revolving piston engine” instead of a reciprocating piston engine or a rotary piston engine. Only twin piston, revolving piston engine is explained here with the help of few drawings. On the same principle a revolving piston engine can be made without much difficulty, to have one or more number of pistons. This type of engines can be used in automobiles, power generation, aero industries, battlefield tanks, and in many other applications. The same concept, with appropriate design changes, can be used to develop a revolving piston air compressor.

### NOMENCLATURE FOR DRAWING SHEETS 1 TO 4

FIG. 1: Schematic representation of the twin piston, “revolving piston engine” showing the probable locations of the inlet and exhaust ports and also showing TDC and BDC equivalent for the engine. The dotted lines show the BDC equivalent position.

FIG. 2: The pitch ellipses for the elliptical gear pair to maintain the varying speed ratio between the revolving piston and the revolving cylinder head. Both the elliptical gears are rotating with respect to the axis passing through the geometrical focal points, 30 and 32, of their pitch ellipses respectively. Eccentricity of the pitch ellipses used for the elliptical gears is approximately 0.38. Positions of the ellipses with dotted lines give a speed ratio of unity.

FIG. 3: Curve showing relationship between instantaneous speed ratio of gear 31 to gear 29 and the rotation 39 of gear 29 from 0° to 720° in the direction 41 in FIG. 2. The negative values in the curve show that the two gears rotate in opposite direction.

FIG. 4: Schematic representation of the revolving piston engine showing the probable gear arrangement and the direction of motion of various main components.

### ENGINE COMPONENTS

The present twin piston, revolving piston engine consists of following major components:

1. Hollow Ring Cylinder:

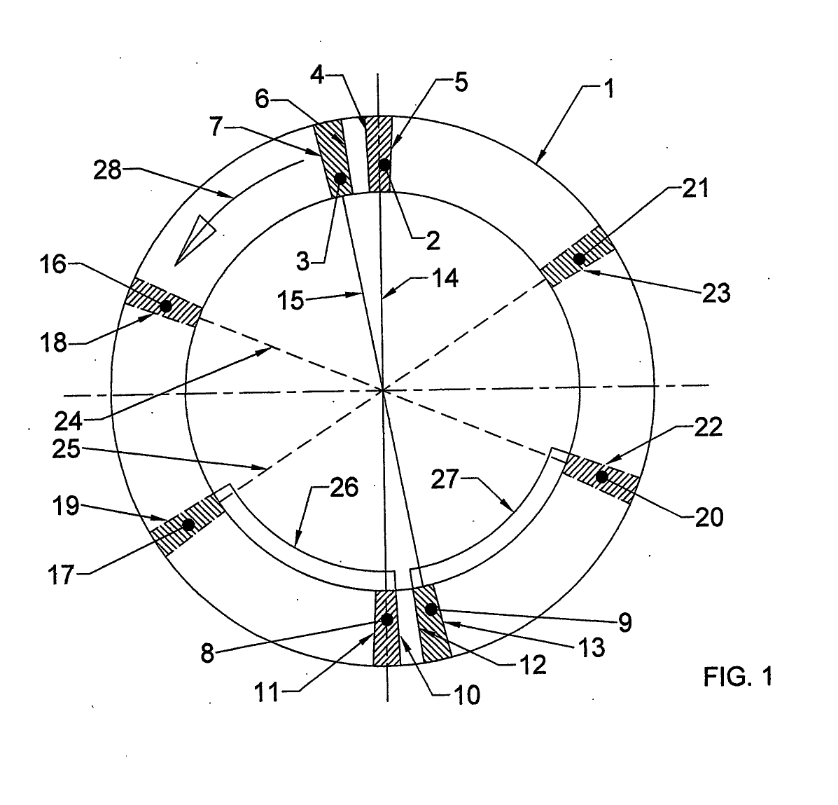

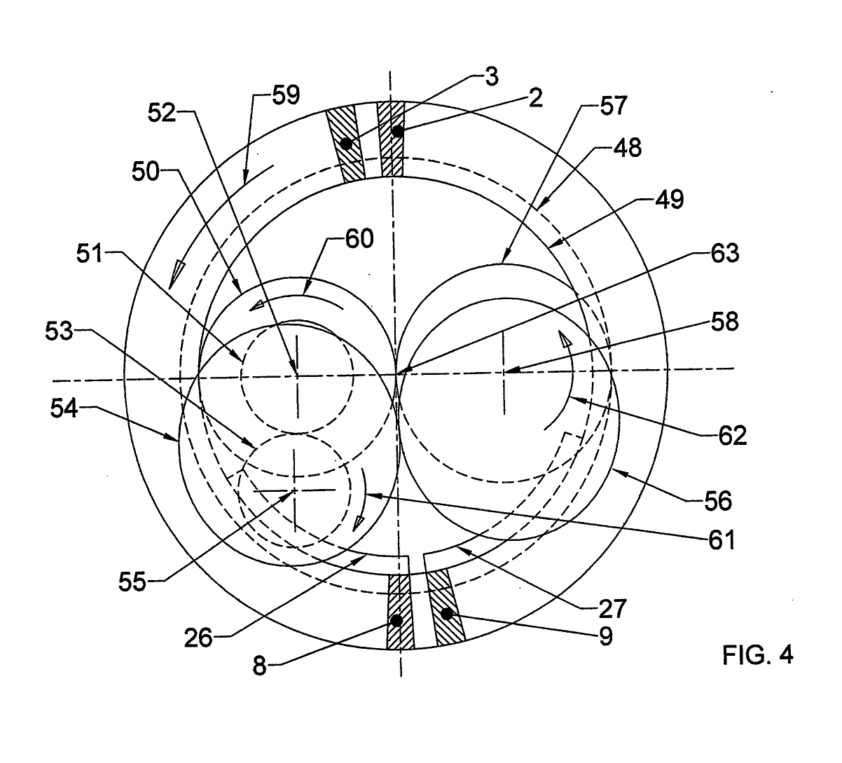

This is a hollow circular ring of any suitable cross-section as represented by 1 in FIG. 1. Revolving a suitable cross-section around an axis, which becomes the common axis, outside the cross-section makes the ring cylinder's geometric shape. This hollow ring is analogous to the cylinder of a conventional reciprocating piston engine, in which the piston slides. Here after the hollow ring cylinder is referred to as “ring cylinder” for easy understanding. The ring cylinder can have any cross-section to give ease of sealing and ease of manufacturing. This ring cylinder may be made of many parts joined together. It has two main components, one is fixed and the other is revolving. The revolving component consists of two assemblies revolving around the common axis that passes through the center, represented by 63 in FIG. 4, of the ring cylinder. These two revolving assemblies, as represented by 48 and 49 in FIG. 4, revolve at different angular speeds and are coupled to each other with a mechanism that regulates the differential angular speed.

2. Revolving Pistons:

In FIG. 1 the two revolving pistons are represented by 3 and 9, in one position and by 17 and 21, in another position. These revolving pistons slide in the ring cylinder and thus revolve around the common axis that passes through the center of the ring cylinder. These revolving pistons are diametrically opposite to each other and are connected to the ring gear assembly 49. The shape of these revolving pistons should suit the sealing requirements of the ring cylinder. As these are analogous to the piston of the conventional reciprocating piston engine, here after these are referred to as pistons instead of revolving pistons.

3. Revolving Cylinder Head:

These are very similar to the pistons but as these act like cylinder head in a conventional reciprocating piston engine, these are called as revolving cylinder heads. In FIG. 1, the two revolving cylinder heads are represented by 2 and 8, in one position and by 16 and 20, in another position. These revolving cylinder heads slide in the ring cylinder and thus revolve around the common axis that passes through the center of the ring cylinder. These revolving cylinder heads are diametrically opposite to each other and are connected to the ring gear assembly 48. The shape of these revolving cylinder heads should suit the sealing requirements of the ring cylinder. These revolving cylinder heads are analogous to the cylinder head of a conventional reciprocating piston engine, as the active volume is trapped between the piston and these parts, here after these parts are referred to as cylinder heads instead of revolving cylinder heads.

4. Ring Gear Supporting the Revolving Pistons:

This is a ring gear assembly with either internal or external gear teeth. For the present engine this ring gear is chosen to have internal gear teeth. The pistons are mounted on this ring gear. This ring gear may form a portion of the inner walls of the ring cylinder and is free to revolve around the common axis that passes through the center of the ring cylinder. Item 49 in FIG. 4 represent this ring gear. In FIG. 1, 15 and 25, represent this ring gear as rigid link in two of its different positions. Here after this ring gear assembly is referred to as ring gear-1.

5. Ring Gear Supporting the Revolving Cylinder Heads:

This is another ring gear assembly with either internal or external gear teeth. For the present engine this ring gear is also chosen to have internal gear teeth. The cylinder heads are mounted on this ring gear. This ring gear may form a portion of the inner walls of the ring cylinder and is free to revolve around the common axis that passes through the center of the ring cylinder. Item 48 in FIG. 4 represent this ring gear. In FIG. 1, 14 and 24, represent this ring gear as rigid link in two of its different positions. Here after this ring gear assembly is referred to as ring gear-2.

6. Linkage to Constrain the Movement of the Two Ring Gears:

This linkage is very important component of the revolving piston engine. This linkage decides the velocity profile of ring gear-2 with respect to that of ring gear-1. For the present engine two elliptical gears in mesh, with their axes of rotation passing through the geometric focus point of their respective pitch ellipses, are used for the linkage purpose. In addition, few circular gears are used in series to obtain the direction of rotation and the overall speed ratio as desired. With this linkage it should be possible to rotate both the ring gears in same direction, with varying speed of ring gear-2 for a constant speed of ring gear-I and keeping same period for both the ring gears to complete their one revolution. It is possible to use other linkages for obtaining the desired varying speeds; one such linkage could be a four bar linkage operating as double crank mechanism.

Principle Of Operation:

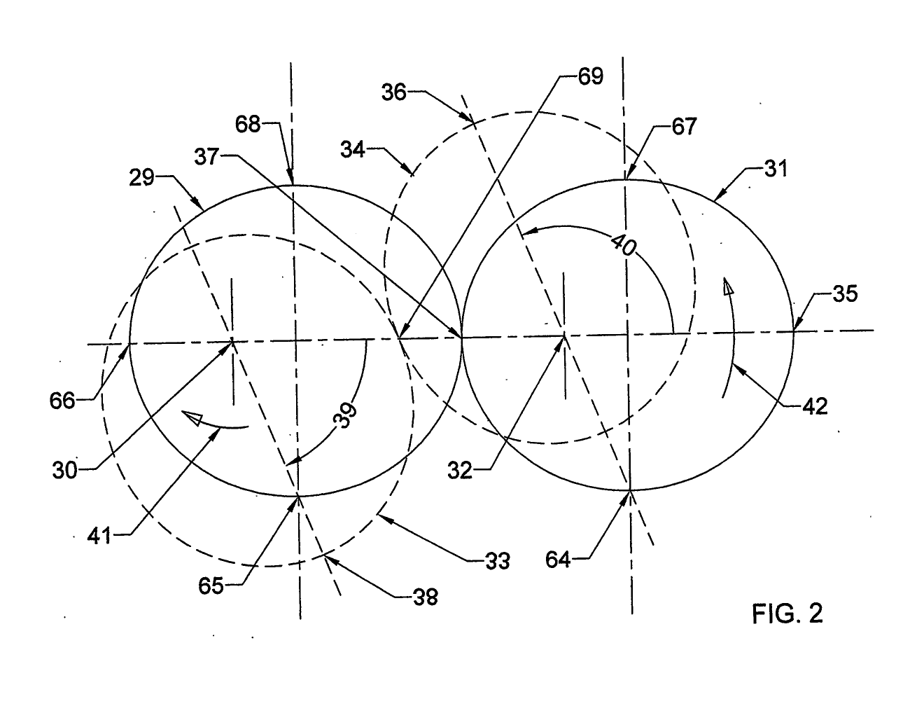

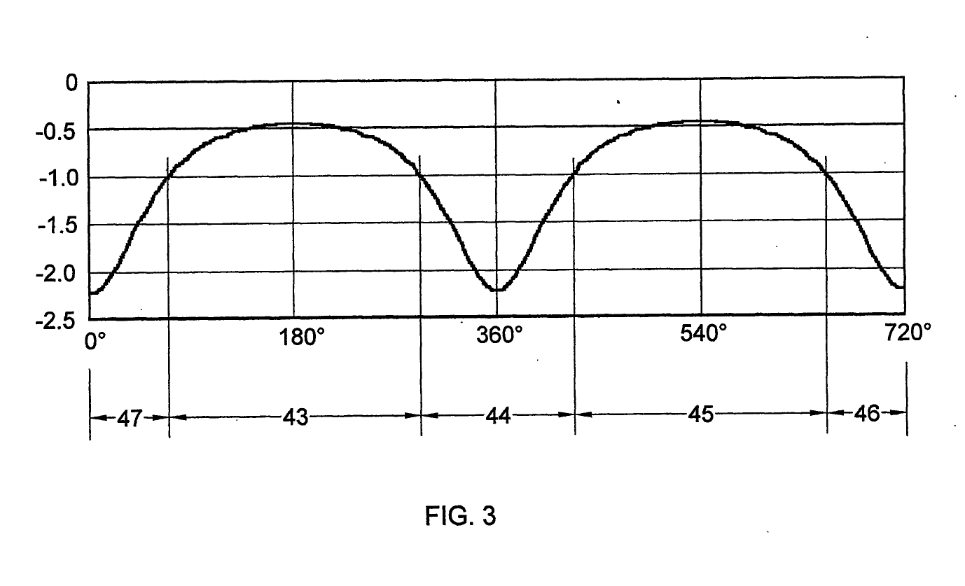

To understand the operation of the engine, it is necessary to understand the functioning of the two elliptical gears. The pitch ellipse used for the two elliptical gears has eccentricity of approximately 0.38. Items 29 and 31, in FIG. 2, represent the elliptical gears. The instantaneous speed ratio between gear 31 to gear 29, with their axes of rotation passing through their respective focal points 32 and 30, with respect to the rotation 39 of the gear 29 in direction shown by 41, is plotted in FIG. 3. The rotation 40 of gear 31, corresponding to the rotation 39 of gear 29 can be calculated from the geometry of the pitch ellipses. In FIG. 3, the horizontal axis represents the rotation 39 of gear 29 in direction 41 from 0° to 720° and the vertical axis represent the instantaneous speed ratio between gear 31 to gear 29. It can be seen from FIG. 3 that the speed ratio varies approximately from −2.22 to −0.45. The negative speed ratio indicates that the direction of rotation 42 of gear 31 is opposite to direction of rotation 41 of gear 29. As both the elliptical gears are identical, they have equal number of teeth and thus simultaneously complete their one revolution. In FIG. 3, it can be seen that at points the speed ratio obtained is unity, at that moment both the elliptical gears rotate at the same instantaneous speed. These positions of the two ring gears, when the speed ratio is unity, are analogous to the TDC and BDC positions in the conventional reciprocating piston engine. The piston and corresponding cylinder head are at closest and farthest to each other in these positions of TDC and BDC respectively.

Engine Kinematics Construction:

The engine has one hollow ring cylinder, represented by 1 in FIG. 1, consisting of fixed and revolving parts. The fixed part of the ring cylinder is used for providing cooling to the cylinder and also has intake port 27 and exhaust port 26, connected to it. The revolving parts of the ring cylinder are mainly made of two ring gears, namely ring gear-1 and ring gear-2. These ring gears also form a part of the inner walls of the ring cylinder. The pistons and the cylinder heads are integral parts of the ring gears assemblies and thus the ring gears revolve with the pistons and the cylinder heads respectively. As the ring gears revolve with the piston and the cylinder heads, proper design of these ring gears can make sealing of the piston and cylinder heads less difficult. The ring gear 49, which has internal teeth, is connected with a spur gear 50 with a speed ratio of 1:2. This spur gear has fixed axis 52 and has another co-axial gear 51 rigidly connected to it. The gear 51 drives another spur gear 53, with speed ratio of unity, having another fixed axis 55. Gear 53 has an elliptical gear 54 rigidly connected to it with the axis 55 passing through the focus of the pitch ellipse of the elliptical gear 54. The elliptical gear 54 drives another elliptical gear 56, which has its fixed axis of rotation 58 passing through the focus of its pitch ellipse. The elliptical gear 56 is rigidly connected to a co-axial spur gear 57. This gear 57 drives the ring gear-2. The speed ratio between the gear 57 and ring gear-2 is 2:1. One flywheel, not shown in the figures, of appropriate size is connected to the ring gear-1 that supports the revolving pistons. Thus the ring gear-1 rotates at half the speed of the elliptical gear 54 and the ring gear-2 rotates at half the speed of the elliptical gear 56. The full gear train ensures that ring gear-1 and ring gear-2 rotate in the same direction. Arrows 59, 60, 61 and 62 show the direction of rotation of different gears. The elliptical gears 54 and 56 are assembled in such a way that they have instantaneous speed ratio of unity when the pistons and the corresponding cylinder heads are closest to each other and the speed of the elliptical gears 56 is tending to reduce as compared to the speed of gear 54 as the gears rotate in the direction shown by 62 and 61 i.e. as the ring gears rotate in the direction shown by 59. It is necessary to mention here that the linkage used here including all the gears for motion transfer from the ring gear-1 to ring gear-2 make a positive drive, as to have motion without slip. Thus the ring gear-1 drives the ring gear-2 with the desired speed variation. The elliptical gear 54 and 56 in mesh thus ensures the differential speeds between pistons and the cylinder heads. It is important to note that the linkage with elliptical gears can be replaced by some other linkage; one such probable linkage could be an appropriate four bar linkage operating as double crank mechanism. An output shaft, which is not shown, is connected to the ring gear-1.

Sequence of Operation:

The gear teeth for all the gears are not shown, instead only pitch circles and pitch ellipses are shown for easy understanding. Consider the piston and cylinder head pair 3 and 2, in FIG. 1 and in FIG. 4. The pitch ellipses 31 and 29 are shown separately for easy understanding, otherwise elliptical gears 56 and 54 have similar pitch ellipses as represented by 31 and 29, and all have the same eccentricity. Thus the curve in FIG. 3 is equally applicable for the elliptical gear pair 56, 54. Thus in FIG. 3, for the portion 43 of the curve, when the speed ratio is less than unity, the elliptical gear 56 rotates slower than the elliptical gear 54 and thus the ring gear-2 and the cylinder head 2 revolves at a slower speed than the speed of revolution of the ring gear-1 and the piston 3. Thus the volume between the faces 4 and 6 keeps on increasing for the portion 43 of the FIG. 3, while revolving in the direction as shown by 28. The positions of the piston and the cylinder head at the start of the portion 43 of the curve in FIG. 3 is represented by 3, 2 and that at the end of portion 43 is represented by 17, 16, in FIG. 1, respectively. Similarly the other pair of piston and the cylinder head at position 9 and 8 at the start of portion 43 attains the positions 21 and 20 respectively, at the end of portion 43 in FIG. 3. The positions of the pistons and cylinder heads at the end of portion 43 are the starting positions for the portion 44 in FIG. 3. At the end of the portion 44 in FIG. 3, piston 3 attains position of piston 9 and piston 9 attains position of piston 3, similarly cylinder head 2 attains the position of cylinder head 8 and cylinder head 8 attains position of cylinder head 2 as represented in FIG. 1. Portion 45 in FIG. 3 is same as portion 43, with the piston-cylinder head pairs 3, 2 and 9, 8 have interchanged their respective positions. Similarly the portion 46 and 47 together is similar to the portion 44, with piston-cylinder head pair 3, 2 attains positions at 21, 20 respectively at the start of the portion 46 and again attains positions 3, 2 at the end of portion 47. Similarly 9, 8 attain positions 17, 16 at the start of portion 46 and again attain positions 9, 8 at the end of the portion 47 respectively. The cycle continues to repeat for further revolutions of the ring gears. Thus for one complete revolution of a piston and cylinder head the elliptical gears require two complete revolutions.

For simplicity, piston-cylinder head pair 3, 2 is called first pair and the pair 9, 8 is called the second pair. In FIG. 3, portion 43 represents the power stroke for first pair and at the same time intake stroke for the second pair. Similarly, portion 44 represents exhaust stroke for first pair and compression stroke for the second pair; portion 45 represents intake stroke for first pair and power stroke for the second pair; portion 46, 47 together represent compression stroke for first pair and exhaust stroke for the second pair.

The fuel ignition should take place appropriately after start of portion 43 or portion 45 for the respective pair. The time delay between start of the portion 43 or 45 and the fuel ignition is to be selected very appropriately and can be varied with engine speed. As the ignition takes place, in the confined space between faces 4 and 6 or in a specially designed combustion chamber outside the confined space, at the time of ignition as stated above, pressure is developed between the two faces forcing them to move apart. Any motion after start of portion 43 or 45, in the direction opposite to 28 will cause the two faces to come closer, this will increase the pressure between the two faces, which is difficult unless the two faces are forced externally to rotate against direction 28. Thus in absence of sufficient external forces the piston 3 and the cylinder head 2 will continue to rotate in the direction 28, by the pressure developed by the ignition of fuel, thus increasing the volume between the two faces 6 and 4. Thus the ignition of fuel or the power stroke will force the piston and thus the ring gear-1 to rotate in the direction 28. Here it is to be noted that in portion 43 and 45, the volume expansion between the faces 6 and 4 is possible only if the two ring gears rotates in the direction 28, which is same as direction 59. As the ring gear-2 and thus the cylinder heads are driven be the ring gear-1, the cylinder head follows the piston in the direction 59 keeping the speed relationship with the piston as constrained by the curve as shown in FIG. 3. During the power stroke, portion 43, the ring gear-2 and thus cylinder heads revolve slower than the piston and the ring gear-1. During the exhaust stroke, portion 44, the ring gear-2 and the cylinder heads revolve faster than the ring gear-1 and pistons, thus forcing the product of combustion out through the exhaust port. During the intake stroke, portion 45, the cylinder heads again revolve slower than the pistons thus increasing the volume between the faces 4 and 6 and thus sucks in the air or air fuel mixture through intake port. During the compression stroke, portion 46 and 47 together, the cylinder heads revolve faster than the pistons and thus reduces the volume between the faces 4 and 6 compressing the air or air fuel mixture and thus making it ready for combustion in power stroke. This above explained cycle repeats for other piston-cylinder head pair 9, 8 keeping 180° phase difference with the pair 3, 2. The faces 12 and 10 in pair 9, 8 are corresponding to the faces 6 and 4 in pair 3, 2. Portions 43, 44, 45, 46 and 47 in FIG. 3, show the zones for ideal strokes for the revolving piston internal combustion engine; the actual start and end of a stroke is decided after considering dynamics of engine, fuel characteristics and many other parameters. Appropriate intake and exhaust valves can replace the intake and exhaust ports.

There can be more pairs of piston and cylinder head for one ring cylinder, or there can be only one pair of piston and cylinder head for one ring cylinder. If there are ‘N’ number of pairs for one ring cylinder than the overall speed ratio between the ring gears to the elliptical gears will be 1:N.

The mechanism that uses elliptical gears can be replaced by some other mechanism that can give desired variation in the speed of the cylinder head for constant piston speed; one such mechanism could be an appropriate four bar linkage operating as a double crank mechanism.

Calculation for the Compression Ratio:

In FIG. 1 the volume between faces 4 and 6 can be assumed as the clearance volume in analogous to the reciprocating piston engine, as piston at 3 and cylinder head at 2 are in positions equivalent to the TDC in a conventional reciprocating piston engine. The volume between faces 18 and 19 can be taken as expanded volume as the piston 3 in position 17 and cylinder head 2 in position 16 are equivalent of BDC in conventional reciprocating piston engine. Similarly volume between faces 10 and 12 is clearance volume for another pair of piston 9 and cylinder head 8, and the volume between faces 22 and 23 is expanded volume as positions 21 and 20 are the BDC equivalent position for piston 9 and cylinder head 8 respectively.

The compression ratio (CR) is the ratio of volume between faces 19 and 18 to that between faces 6 and 4.

In other words CR=(angle from 18 to 19)/(angle from 4 to 6);

CR=((angle from 15 to 25)−(angle from 14 to 24)+(angle from 4 to 6))/(angle from 4 to 6)

All the angles mentioned above are measured in the direction 28. Angle from 15 to 25 is the ratio of rotation of elliptical gear 29 for the portion 43 to the speed ratio between elliptical gear and the ring gear-1. Similarly angle from 14 to 24 is the ratio of rotation of elliptical gear 31 for the portion 43 to the speed ratio between elliptical gear and the ring gear-2. These angles can be calculated from the geometry of the pitch ellipse as shown in FIG. 2. The pitch ellipse used for the elliptical gears is having length of major axis (distance from 35 to 37 or 37 to 66) as 80 units and length of minor axis (distance from 64 to 67 or 65 to 68) as 74 units, thus the eccentricity is 0.3799671. For the TDC position, the two elliptical gears are shown by 33 and 34, having the instantaneous speed ratio between them as unity and thus in this position length between 32 and 69 is equal to the length between 30 and 69. Here 30 and 32 are the focal points of the respective ellipses and 69 represent the point of contact of the two pitch ellipses.

As the speed ratio between elliptical gears to ring gears is 2:1 and the pitch ellipses are symmetrical about their major and minor axes.

Angle from 15 to 25=angle between lines 38-30 and 30-66 OR angle from 15 to 25=angle between lines 65-30 and 30-66=112.332°

Similarly,

$$\begin{matrix}Angle from 14 to 24 = Angle between lines 36 \text{-} 32 and 32 \text{-} 37 \\ = Angle between lines 64 \text{-} 32 and 32 \text{-} 35 \\ = 67.668 °\end{matrix}$$

If we have clearance angle as 4°, then CR=(112.332-67.668+4)/(4)=12.163

If the clearance angle is changed to 5° then for the same engine the CR becomes (112.332-67.668+5)/(5)=9.9328

Thus it can be seen that just by changing the clearance angle the CR can be changed very easily. The CR can also be changed easily by selecting pitch ellipses with different eccentricity. It can be seen that lower the eccentricity of pitch ellipses, lesser is the CR obtained. It is to be noted here that, for the calculations faces 4, 6, 18, 19, etc. are assumed to be planer faces and the planes of the faces pass through the common axis of revolution.

Calculation for Output Power:

The volume between faces 3 and 2 acts as the active volume. After TDC the charge between faces 3 and 2 is ignited. As the result of combustion, the pressure between the faces 3 and 2 increases and forces the volume between the faces to increase and thus forces the ring gears to rotate in CCW direction as shown in FIG. 4. The theoretical power generated can be calculated with the standard power generation equation:

$$W = {\int }_{CV}^{CV * CR} p \cdot ⅆ v$$

Where:
W=Work done OR power generated,
CV=clearance volume,
CR=compression ratio,
p=pressure of the active volume,
v=volume of the active volume.

Some power is always lost in compressing the air or air-fuel mixture in the active volume. Some power is also lost in accelerating and decelerating the ring gear-2 assembly supporting the revolving cylinder heads and associated linkages. The loss of power in acceleration and deceleration depends upon the total mass and inertia of the components undergoing speed variation. It is advisable to keep the mass and the inertia of such parts to a minimum as to reduce the losses. The difference between the power generated and the power lost becomes available for utilization outside the engine.

Advantages of the Revolving Piston Engine:

1. This concept revolving piston engine does not have any reciprocating part.
2. This engine is suitable for all types of fuels and different ignition methods those can be used in reciprocating piston engine. The combustion chamber can also be designed outside the ring cylinder.
3. Use of ports for intake and exhaust are possible instead of valves to operate, this makes the engine more robust. Thus in this way a four stroke engine can be made to work with ports.
4. While combustion takes place and while product of combustion expands the active volume between the corresponding faces of the piston and cylinder head revolves in the ring cylinder; thus creating a revolving heat source making cooling easy and efficient. This also provides more surface area available for cooling.
5. Large portion of the ring cylinder is fixed making it suitable for easy cooling by liquid coolant or any other cooling method.
6. Same ring cylinder can accommodate one to many pairs of pistons and cylinder heads allowing higher power generation possible for approximately same physical size of the engine. This also allows higher power to weight ratio obtainable with less modifications.
7. Vibration levels will be very low as the reciprocating components are absent and the pistons and cylinder heads can be arranged in such a way that they balance other pistons and cylinder heads within the same ring cylinder.
8. This engine can be used as an engine module. Similar engines can be put together in parallel with a common output shaft; thus it is easy to increase power output without much change in the design.
9. It is possible to use multiple engines at a time with a common output shaft to make an equivalent of multi-cylinder reciprocating piston engine. The engine can be designed for ease of interchangeability and thus making it possible to keep an engine as a spare and use it to replace a faulty engine in emergency with ease and with minimum down time required for the engine repair.
10. While using multiple engines, it is possible to arrange the different engines on same output shaft in a way as to have a power stroke in one engine overlapping compression stroke in other engine, for obtaining smooth power output and thus possibly reducing the size of the flywheel.
11. Instead of elliptical gear pair some other mechanism can be used to obtain desired differential velocity for the two ring gears supporting the pistons and cylinder heads. An ideal differential velocity pattern is that which will give maximum separation between the revolving piston and revolving cylinder head during power and intake strokes with minimum acceleration and deceleration keeping the clearance volume to a minimum.
12. It is possible to use the space between faces 7, 11 and faces 13, 5 for pre-compression of the separately filled air or air fuel mixture during intake stroke or power stroke and supplying it to the active volume between 6, 4 and 12, 10 appropriately during compression stroke. This can be used to increase the output power as in super charging of the engine.
13. A very compact engine can be made as it contains less number of parts.
14. It can be suitably designed to have less down time while repairing the engine.
15. The ring cylinder can have any suitable cross-section as required for easy manufacture and assembly.
16. The engine's expected life is longer as it has no reciprocating part and very effective cooling is possible. The engine heating is less because of revolving active volume.
17. It is possible to mount spark plug on to the piston itself to have better control on the ignition timing and thus eliminating the need of separate combustion chamber.
18. It is very easy to use this principle to develop a revolving piston compressor for that the ports or the valves are to be appropriately designed and relocated. In such applications portions 44, 46 and 47 are used for compression strokes and portions 43 and 45 are used for intake strokes. The input power is to be supplied to the ring gear-1.
   Disadvantages of the Revolving Piston Engine:
1. As the ring cylinder is made of many components that are revolving at different speeds, proper sealing may be difficult.
2. Gear wearing out may affect the performance of the engine.
3. As parts of the inner walls of the ring cylinder are revolving and not fixed, cooling of these components may be difficult.
4. Some vibrations may be induced because of the eccentric loading of the elliptical gears.
5. Manufacturing of elliptical gears may pose some difficulty, as it is not regularly used and not very common.
6. As the ring cylinder can be made with any cross-section, it may become difficult to provide proper sealing for non-circular cross-section of piston and cylinder heads.
7. As there are two piston like structures for a single active volume thus we have to seal the active volume from two sides as against only one side sealing of the active volume is sufficient in the conventional reciprocating piston engine.
8. As in the present design internal gears are used for ring gears, it is possible to use external gears for ring gears to utilize the benefits of external gears.

1. An arrangement which has one ring like fixed part, called fixed ring, with a suitable cross section, one common axis which is also the axis of the fixed ring, two assemblies revolving around the common axis in same direction with varying relative speed but having same cycle time; one of the two assemblies has one or more similar looking components rigidly fixed to it, these components are called as revolving cylinder heads; other assembly also has another type of similar looking components rigidly fixed to it, that are called as revolving pistons; these revolving pistons and the revolving cylinder heads slide with respect to the fixed ring, for a fixed ring the number of revolving pistons is equal to that of the revolving cylinder heads, these individual revolving cylinder head with one revolving piston forms a pair; more than one pairs can be used with a fixed ring; the volume trapped between the revolving cylinder head and revolving piston of a pair, the fixed ring and the two assemblies is the controlled active volume; the relative speeds for the two assemblies varies in a gradual manner and is selected in such a way that at times one of the assemblies become slower than the other and at times it becomes faster than the other thus forcing controlled variation in the controlled active volume; each of the revolving assemblies per fixed ring have one ring gear rigidly connected to it, with either internal or external teeth as per the specific requirement to transfer motion to the two assemblies from a mechanism that controls the relative velocity profile of the two assemblies; openings are provided in the fixed ring and in the revolving assemblies as to connect and disconnect the controlled active volume to the intake manifold and exhaust or outlet manifold appropriately during the revolution of the two assemblies, thus making it possible to avoid the use of conventional valves for the purpose; a shaft that is coaxial with the common axis and is connected to one of the revolving assemblies, is used as output shaft.

2. The arrangement as claimed in claim 1 that uses a mechanism for controlling the relative velocity of the revolving assemblies; the mechanism consists of two elliptical gears in engagement, with identical pitch ellipses, with the axis of rotation for the individual elliptical gear passing through the geometric focus point of the respective pitch ellipse; the distance between the two axes of rotation for the two elliptical gears is equal to the length of the major axis of the pitch ellipse; motion input to one of the elliptical gear, called input elliptical gear, is provided through an input shaft that is rigidly connected to the input elliptical gear and is coaxial to its axis of rotation; output motion from the engaged elliptical gear, called output elliptical gear is obtained through an output shaft that is rigidly connected to the output elliptical gear and is coaxial to its axis of rotation; thus for a constant input speed of the input shaft, the output shaft has a speed that varies from a higher speed to a lower speed and again to higher speed as compared to the speed of the input shaft during every revolution of the two engaged elliptical gears; the input shaft is connected through some gearing or through some positive drive to the respective ring gear and thus to one of the revolving assemblies; the output shaft is connected to the ring gear of the other revolving assembly through some gearing or through some positive drive; the gearing or the positive drive that connect the engaged elliptical gears and the ring gears is designed in such a way that both the assemblies revolve in same direction, and if the arrangement as in claim 1 has one or two pairs of revolving piston and revolving cylinder head attached to fixed ring, then for every revolution of revolving piston and revolving cylinder head pair, the engaged elliptical gears complete two revolutions; for higher number of revolving piston, revolving cylinder head pairs attached to fixed ring, the speed ratio between the respective assemblies and the elliptical gears is to be decided appropriately.

3. An arrangement as claimed in claim 2 that uses a four bar linkage that acts as a double crank mechanism or some other mechanism for controlling the variation in the relative velocity of the two revolving assemblies in place of the use of two elliptical gears in engagement.

4. The arrangement as claimed in claim 1, which is used to make a revolving piston internal combustion engine by using different phases of the controlled variation in the controlled active volume appropriately as equivalent of intake stroke, compression stroke, power stroke and the exhaust stroke, during the revolution of the two assemblies; suitable for the revolving piston and the revolving cylinder head and the fixed ring, intake and exhaust ports or valves or combination of the two are provided for purpose of controlling the intake and exhaust; the actual combustion may take place within the controlled active volume or in a specially designed combustion chamber out side the controlled active volume.

5. The engine as claimed in claim 4, in which the space between the revolving pistons of one pair and revolving cylinder head of other pair is used for the purpose of pre-compression of the air or air fuel mixture.

6. The engine as claimed in claims 1, 4 and 5, in which the spark plug is mounted on to the revolving piston or revolving cylinder head.

7. The engine as claimed in claims 1, 4, 5 and 6, that has a flywheel and output shaft connected to one of the two revolving assemblies.

8. Two or more of the engines as claimed in claims 1, 4, 5, 6 and 7 are used at a time in parallel with a common output shaft; the engines may be arranged in such a way that a power stroke in one engine overlap with a compression stroke in other engine; the engines may also be arranged in such a way that the power strokes in different engines take place at different timings as to have less fluctuations in power output and to reduced vibrations; the capacities of different engines can be different.

9. Two or more of the engines as claimed in claims 1, 4, 5, 6 and 7 are used, as separate engine modules, at a time in parallel with a common output shaft; the engine fittings are specially designed for interchangeability to allow use of a single separate engine as a spare for replacement of a faulty engine out of many parallel engines; additional engines can be used with the common output shaft to increase power output.

10. The arrangement as claimed in claim 1 to 3, which is used to make a revolving piston compressor using the expansion and compression of the controlled active volume appropriately, incorporating appropriate redesign and relocation of the intake and outlet ports or valves.

11. Two or more compressors as claimed in claim 10, arranged in series or parallel making an equivalent of a multistage or multi cylinder compressor.

12. The engine or the compressor as claimed in claims 1 to 11 which uses any type of lubrication system and is used for any purpose.
